(19) United States
(12) Patent Application Publication
(10) Pub. No.: US 2018/0341231 A1
(43) Pub. Date: Nov. 29, 2018

(54) Method for Operating a Cyclically Operating Automation Controller, Automation Controller and Engineering System

(71) Applicant: Siemens Aktiengesellschaft, Muenchen (DE)

(72) Inventors: Thomas Goetz, Schmidgaden (DE); Peter KOB, Heroldsberg (DE)

(21) Appl. No.: 15/985,246

(22) Filed: May 21, 2018

(30) Foreign Application Priority Data
May 24, 2017 (EP) EP17172848.8

(51) Int. Cl. G05B 11/06; G05B 15/02; G05B 19/042

(52) U.S. Cl. CPC G05B 11/06; G05B 2219/24137; G05B 19/0423; G05B 15/02

(57) ABSTRACT

A method for operating a cyclically operating automation controller, the method being executed within a cycle time of the automation controller, wherein input data is read from input peripherals (1^{st} Step), the input data is stored in a process image memory for inputs, a user program is launched (3^{rd} Step), a plurality of program instructions generating output data based on the input data stored in the process image memory for inputs, the output data is stored in a process image memory for outputs after execution of the last program instruction, the output data from the process image memory for outputs is written to output peripherals, where data backup of remanent data is performed within a time window which opens upon completion of the 3^{rd} step and recloses upon commencement of the 1^{st} step.

### BACKGROUND OF THE INVENTION

### 1. Field of the Invention

The invention relates to a method for operating a cyclically operating automation controller, where the method is executed within a cycle time of the automation controller; to an automation controller operable to process program instructions within a cycle time, comprising an operating system, means for reading input data from input peripherals, means for storing the input data in a process image memory for inputs, means for executing a user program, where a plurality of program instructions generate output data based on the input data stored in the process image memory for inputs, means for storing the output data in a process image memory for outputs, means for writing the output data from the process image memory for outputs to output peripherals, and relates to an engineering system for configuring the above-described automation controller.

### 2. Description of the Related Art

In the case of automation devices for industrial control processes, it is desirable to perform data backup. Data backup of this kind, particularly with respect to remanent data, has hitherto been performed by a user. For this purpose, the user has had to place the automation device, i.e., the automation controller, in a stop state so that the remanent data to be backed up (e.g., data block or flags, timers, counters, timing elements) is no longer affected by the process. In the stop state, both the program and all the remanent values can be consistently backed up.

In the context of the instant invention, the term remanent data is to be understood as follows: Remanent data is data that is available again when the automation controller is restarted, despite the automation controller having been switched off in the meantime. In automation technology, remanence is the ability of operands to retain their values following loss of voltage.

### SUMMARY OF THE INVENTION

It is an object of the present invention to provide a method for backing up remanent data without requiring the user to place the automation controller into a stop state.

This and other objects and advantages are achieved in accordance with the invention by a method for operating a cyclically operating automation controller in which input data is read from input peripherals (1^{st} step), the input data is stored in a process image memory for inputs (2^{nd} step), a user program is launched (3^{rd} step), where a plurality of program instructions generate output data based on the input data stored in the process image memory for inputs, the output data is stored in a process image memory for outputs after execution of the last program instruction (4^{th} step), the output data from the process image memory for outputs is written to output peripherals (5^{th} step), where remanent data is backed up within a time window that opens with the end of the third step and recloses with the start of the first step. Data backup can now occur while the automation controller is in a run state, but inventive use is now made of the fact that cyclical processing means that a point in time exists that ensures consistency with respect to the data. This point in time is determined by the copying of a process image to the output peripherals. Data backup must therefore occur before this action is completed.

As preferably only the remanent data needs to be backed up consistently, this time interval is comparatively short in relation to the cycle time and will not therefore appreciably affect a total cycle time.

In an advantageous further embodiment of the method, the remanent data to be backed up is temporarily stored in a remanence memory and data is backed up onto an external medium separate from the automation controller within the time window over a plurality of cycles in fractional amounts of the entire data content of the remanence memory in each case so that the cycle time of the automation controller does not exceed a maximum predefined cycle time. Remanent data backup is thus distributed over a plurality of cycles.

For the automation controller mentioned in the introduction this object is achieved by the operating system being configured and operable to ensure that data backup of remanent data occurs within a time window, where the time window is opened upon completion of the last instruction in the user program and is closed with the commencement of reading of the input data. Due to the characteristics of an automation controller operating in a cycle-oriented manner, there is single volatile area which, however, must in turn be backed up consistently and an area which remains unchanged, e.g., the program code.

Another embodiment of the automation controller provides that means are available which are configured and operable to temporarily store the remanent data to be backed up in a remanence memory and to perform data backup onto an external medium separate from the automation controller in each case in fractions of the entire data content of the remanence memory over a plurality of cycles within the time window in each case, so that the cycle time of the automation controller does not exceed a maximum predefined cycle time.

With regard to the program code and nonvolatile data, the program code data can be backed up over a long period, since the contents do not change. Remanent data, on the other hand, is consistently backed up in a step or written to a separate area that must then be backed up later. In the event of repeated data backup, only remanent data needs to be backed up again, as the other data has not changed. The program code data would only need to be backed up again after the software has been re-downloaded to the automation controller.

With regard to an engineering system, the object is achieved by the user now being provided with means, within the engineering system, of setting up data backup using the following settings: data backup on or off, manual or automatic operation, select length of time window. The data backup times can also be specified, similarly to a clock timer, e.g., the data can be backed up during the night shift when there is less process activity. It is also conceivable for the pieces of data to be predefined, in other words to specify the fractions of the entire data content of the remanence memory.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The drawings show an exemplary embodiment for the method, for the automation controller and for the engineering system, in which:

FIG. 1 shows a program flowchart for the method for operating a cyclically operating automation controller in accordance with the invention;

FIG. 2 shows the steps of a cyclically operating automation controller according to the prior art in accordance with the invention;

FIG. 3 shows the steps for the automation controller using the inventively introduced time window for data backup; and

FIG. 4 shows an automation controller adapted with respect to data backup within a time window, with a connected engineering system.

### DETAILED DESCRIPTION OF THE EXEMPLARY EMBODIMENTS

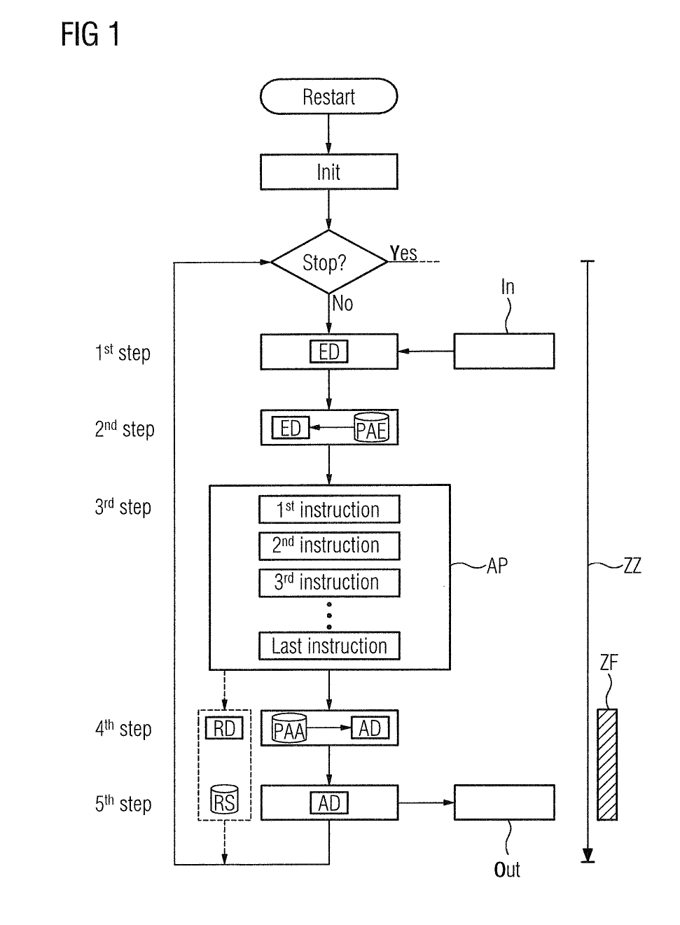

FIG. 1 shows a program flowchart for the method for operating a cyclically operating automation controller 10. Performed within a cycle time ZZ in the automation controller 10 are a first step: reading of input data ED from input peripherals In, a second step: storing of the input data ED in a process image memory for inputs PAE, a third step: launching of a user program AP, where a plurality of program instructions generate output data AD based on the input data ED stored in the process image memory for inputs PAE, a fourth step: storing of the output data AD in a process image memory for outputs PAA after execution of the last program instructions, a fifth step: writing of the output data AD from the process image memory for outputs PAA to output peripherals Out. After the fifth step, the cycle is repeated starting with the first step.

In order to arrive at the above-described cyclically operating steps, a restart of the automation controller 10 accompanied by an initialization phase is assumed. After a restart, generally all outputs, timers, counters and flags are set to zero. As a CPU can be placed in a stop state using a switch, for example, an inquiry is made each time prior to the first step as to whether the CPU is at a stop. The input data ED is now read via external peripheral equipment and, after execution of the user program AP, the output data AD is output to external output peripheral equipment, or more specifically output peripherals Out.

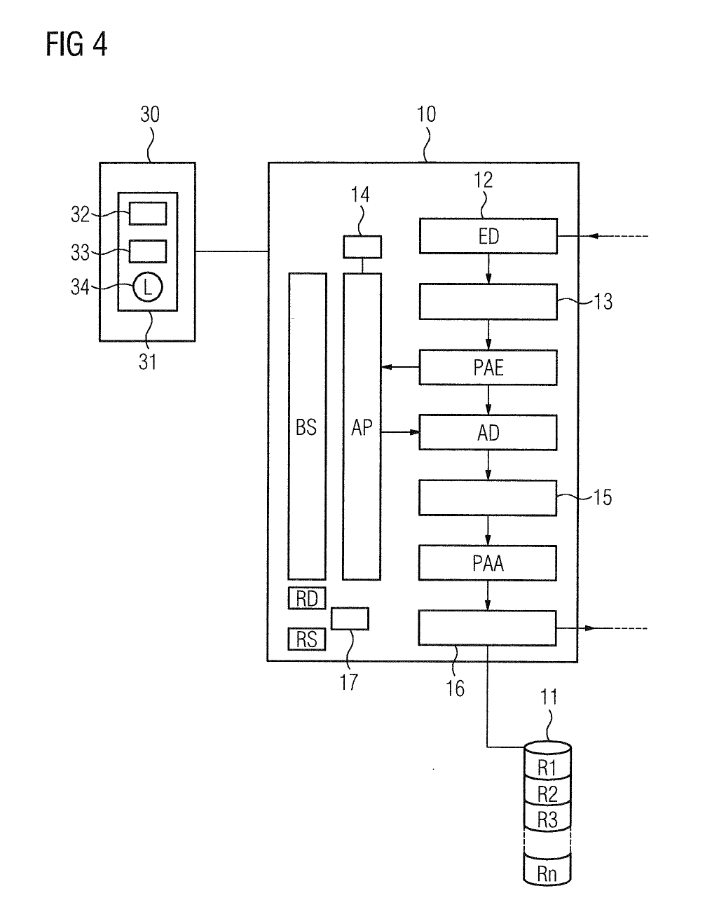

In accordance with the invention, data backup of remanent data RD is now performed within a time window ZF that opens with the end of the third step and closes again with the start of the first step. This saving of the remanent data RD to a remanence memory RS within the time window ZF is indicated in the dashed box. It makes sense for the remanent data RD to be temporarily stored in the remanence memory RS and for data backup to a medium 11 (see FIG. 4) separate from the automation controller 10 to be performed within the time window ZF over a plurality of cycles in fractions R1, R2, R3, . . . , Rn of the total data content of the remanence memory RS in each case, so that the cycle time ZZ of the automation controller 10 does not exceed a maximum predefined cycle time.

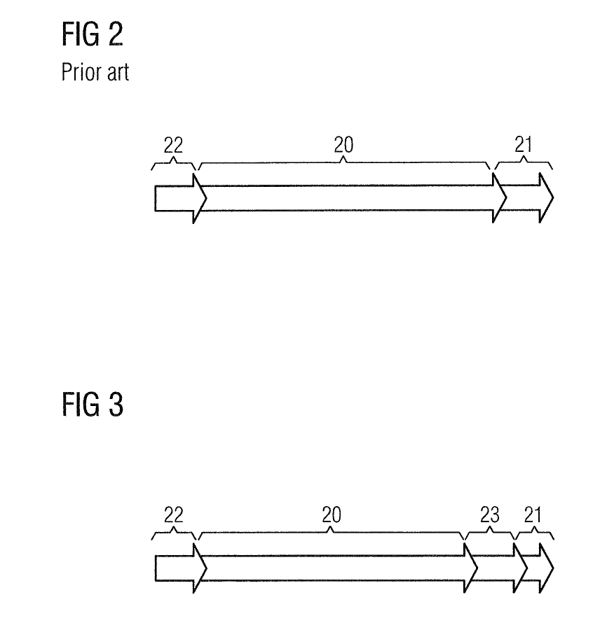

FIG. 2 shows the basic cyclical behavior of a cyclically operating automation controller 10 in accordance with the prior art. Program execution 20 of the user program AP occurs between a read operation 22 for the input data ED of the input peripherals In and a write operation 21 of the output data AD to the output peripherals Out.

FIG. 3 shows the inventive insertion of a backup operation 23 at a certain point and at a certain time. Following program execution 20 of the user program AP, remanent data can be consistently saved by the backup operation 23, because the data remains unchanged in this time interval.

FIG. 4 shows an automation controller 10 with an associated engineering system 30. The automation controller 10 is configured to execute program instructions in its user program AP within the cycle time ZZ. For the internal organization the automation controller 10 has an operating system BS. The automation controller 10 incorporates a means 12 for reading the input data ED from the input peripherals In, means 13 for storing the input data ED in a process image memory for inputs PAE, a means 14 for executing a user program AP, where a plurality of program instructions generate output data AD, based on the input data ED stored in the process image memory for inputs PAE. In order to re-write the output data AD to output peripherals Out, the automation controller 10 also has means 15 for saving the output data AD to a process image memory for outputs PAA and, lastly, means 16 for writing the output data AD from the process image memory for outputs PAA to the output peripherals Out.

The operating system BS is now inventively configured such that, for consistent data backup RD of the remanent data, the remanent data RD is backed up within a time window ZF, with the time window ZF being opened upon completion of the last instruction in the user program AP and closed upon commencement of reading of the input data ED.

The automation controller additionally has means 17 configured and operable to temporarily store the remanent data RD to be backed up in a remanence memory RS and to perform data backup onto an external medium 11 separate from the automation controller 10 in fractions R1, R2, R3, . . . , Rn of the total data content of the remanence memory RS over a plurality of cycles within each time window ZF, so that the cycle time of the automation controller 10 does not exceed a maximum predefined cycle time.

Via a connected engineering system 30 with which the automation controller 10 is normally configured and programmed, the user can now select the data backup type via means 31 for setting consistent data backup of the remanent data RD using the following setting options: a data backup 32 “on” or “off” option, a “manual” or “automatic” operation 33 option and an option for setting the selected length of the time window ZF in order to adjust the cycle time ZZ.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for operating a cyclically operating automation controller, the method being executed within a cycle time of the automation controller, the method comprising:
reading input data from input peripherals;
storing the input data in a process image memory for inputs;
launching a user program, a plurality of program instructions generating output data based on the input data stored in the process image memory for the inputs;
storing the output data in a process image memory for outputs after execution of a last program instruction;
writing the output data from the process image memory for outputs to output peripherals;
wherein data backup of remanent data is performed within a time window which opens upon completion of said launch of the user program and recloses upon commencement of said reading input data from input peripherals.

2. The method as claimed in claim 1, wherein the remanent data to be backed up is temporarily stored in a remanence memory and each data backup onto an external medium separate from the automation controller is performed in fractions of a total data content of the remanence memory over a plurality of cycles within each time window, so that the cycle time of the automation controller does not exceed a maximum predefined cycle time.

3. An automation controller operable to process program instructions within a cycle time, comprising:
an operating system;
means for reading input data from input peripherals;
means for storing the input data in a process image memory for inputs;
means for executing a user program, a plurality of program instructions generating output data base on the input data stored in the process image memory for inputs;
means for storing the output data in a process image memory for outputs;
means for writing the output data from the process image memory for outputs to output peripherals,
wherein the operating system is operable to ensure data backup of remanent data is performed within a time window, the time window being opened upon completion of a last instruction in the user program and closing upon commencement of reading of the input data.

4. The automation controller as claimed in claim 3, further comprising:
means operable to temporarily store the remanent data to be backed up in a remanence memory and to perform each data backup onto an external medium separate from the automation controller in fractions of a total data content of the remanence memory over a plurality of cycles within each time window, such that the cycle time of the automation controller does not exceed a maximum predefined cycle time.

5. An engineering system for configuring the automation controller as claimed in claim 3, comprising:
means for setting data backup via the following setting options:
data backup on or off,
manual or automatic operation,
select length of time window.
